(19) United States
(12) Patent Application Publication
(10) Pub. No.: US 2009/0276066 A1
(43) Pub. Date: Nov. 5, 2009

(54) INTERLEAVING CONTINUITY RELATED AUDIO FRAGMENTS BETWEEN SEGMENTS OF AN AUDIO FILE

(75) Inventors: Sean Callanan, Dublin (IE); Thomas J. Dinger, Sunnyvale, CA (US); Michael Roche, Dublin (IE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/112,647

(22) Filed: Apr. 30, 2008

(51) Int. Cl. G06F 17/00

(52) U.S. Cl. 700/94

(57) ABSTRACT

A method for generating an audio file is provided. The method can include receiving a plurality of data entries, wherein each data entry comprises a text portion and converting the text portion of each data entry into a data audio segment, thereby generating a plurality of data audio segments. The method can further include generating, for each data entry in a subset of the plurality of data entries, an introduction audio segment that describes a data entry, thereby producing a plurality of introduction audio segments. The method can further include concatenating the plurality of data audio segments and the plurality of introduction audio segments into a single audio file, wherein each introduction audio segment is positioned in the audio file directly prior to a data audio segment corresponding to the data entry described by the introduction audio segment.

### BACKGROUND OF THE INVENTION

1. Field of the Invention

The present invention relates to mobile computing devices, and more particularly relates to improved audio files for mobile communications devices.

2. Description of the Related Art

Individuals involved in business and/or academia must deal with a growing array of incoming information during the course of a business or school day. On any given week day, business individuals and students must manage numerous emails, handfuls of calendar appointments, various documents and multiple other entries. Throughout the day, the individual receives the various data items and evaluates, responds, files and/or executes them. Often times, the individual must travel or move to a location away from his computer, which reduces the amount of time available to the individual to manage the various data items. During such instances, the individual may fall behind in managing the various data items. As such, when he returns to his computer, the individual must catch up on the various emails, calendar entries and documents that have piles up while he was away.

The emergence of the internet and small computing devices, such as smart phones and media players, has enabled users to experience various types of media, such as audio, video and movie files in a mobile manner. To this end, users have started to use this paradigm to listen to their business-related data entries in a mobile manner. Specifically, currently available software allows a user to convert her emails, calendar appointments, documents and other entries into an audio file using text-to-speech conversion software. Then, the audio file is downloaded to her smart phone or media player so that the user can listen to the data entries while she is commuting, waiting in line or making dinner. This solution entails the conversion of text in emails, calendar appointments, documents and other entries to audio which is concatenated into one audio file and then provided to the user as a single audio experience. This approach, however, does not come without its drawbacks.

One problem with the current approach is that the audio file, which is a simple recitation of the text in the data entries, can be monotonous and boring. This results in listeners tuning out or failing to listen to the audio file after a period of time. Another problem with this approach is the lack of clear breaks between entries, since entries are strung or concatenated together according to a random or predefined system and a single voice is used to broadcast the entry. This results in listeners missing all of, or at least the beginning portion of, an entry. Yet another problem with this approach is the lack of any indicators of remaining entries or remaining time in the audio file. Because no such indicators are provided, during playback of the audio file listeners have no idea how many entries remain or how much time is left on the audio file. This can be disconcerting and annoying for listeners.

Therefore, a need arises for improvements over the prior art and in particular for a more efficient method for providing a user an acoustic method for experiencing his data files, including emails, calendar appointments, documents and other entries.

### BRIEF SUMMARY OF THE INVENTION

Embodiments of the present invention address deficiencies of the art in respect to mobile computing devices and provide a novel and non-obvious method and system for generating an audio file describing data entries, wherein the audio file includes continuity audio segments. In one embodiment of the invention, a method for generating an audio file is provided. The method can include receiving a plurality of data entries, wherein each data entry comprises a text portion and converting the text portion of each data entry into a data audio segment, thereby generating a plurality of data audio segments. The method can further include generating, for each data entry in a subset of the plurality of data entries, an introduction audio segment that describes a data entry, thereby producing a plurality of introduction audio segments. The method can further include concatenating the plurality of data audio segments and the plurality of introduction audio segments into a single audio file, wherein each introduction audio segment is positioned in the audio file directly prior to a data audio segment corresponding to the data entry described by the introduction audio segment.

In another embodiment of the invention, a system on a computer for generating an audio file is provided. The system can include a repository for storing a plurality of data entries, wherein each data entry comprises a text portion. A data entry can be an email, a calendar entry or a document. The system can also include a processor configured for converting the text portion of each data entry into a data audio segment, thereby generating a plurality of data audio segments, and generating, for each data entry in a subset of the plurality of data entries, an introduction audio segment that describes a data entry, thereby producing a plurality of introduction audio segments. The processor may also be configured for concatenating the plurality of data audio segments and the plurality of introduction audio segments into a single audio file, wherein each introduction audio segment is positioned in the audio file directly prior to a data audio segment corresponding to the data entry described by the introduction audio segment.

In another embodiment of the invention, a computer program product comprising a computer usable medium embodying computer usable program code for generating an audio file is provided. The computer program product may include computer usable program code for receiving a plurality of data entries, wherein each data entry comprises a text portion and converting the text portion of each data entry into a data audio segment, thereby generating a plurality of data audio segments. The computer program product may further include computer usable program code for generating, for each data entry in a subset of the plurality of data entries, an introduction audio segment that describes a data entry, thereby producing a plurality of introduction audio segments. The computer program product may further include computer usable program code for concatenating the plurality of data audio segments and the plurality of introduction audio segments into a single audio file, wherein each introduction audio segment is positioned in the audio file directly prior to a data audio segment corresponding to the data entry described by the introduction audio segment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a system for generating an audio file describing data entries and transferring the audio file to a mobile computing device, according to one embodiment of the present invention;

FIG. 2A is a block diagram illustrating a process for generating an audio file describing data entries, wherein the audio file includes continuity segments, according to one embodiment of the present invention; and

FIG. 2B is a continuation of the block diagram of FIG. 2A.

### DETAILED DESCRIPTION OF THE INVENTION

Embodiments of the present invention address deficiencies of the art in respect to mobile computing devices and provide a novel and non-obvious method and system for generating an audio file describing data entries, wherein the audio file includes continuity audio segments. The method for generating the audio file includes receiving a plurality of data entries, such as emails, calendar entries and word processing documents. Each data entry comprises a text portion. Next, the text portion of each data entry is converted into a data audio segment using a text-to-speech conversion program. An introduction audio segment that describes a data entry is generated for a subset of the plurality of data entries. Then, the data audio segments and the introduction audio segments are concatenated into a single audio file, wherein each introduction audio segment is positioned in the audio file directly prior to the data audio segment corresponding to the data entry introduced by the introduction audio segment.

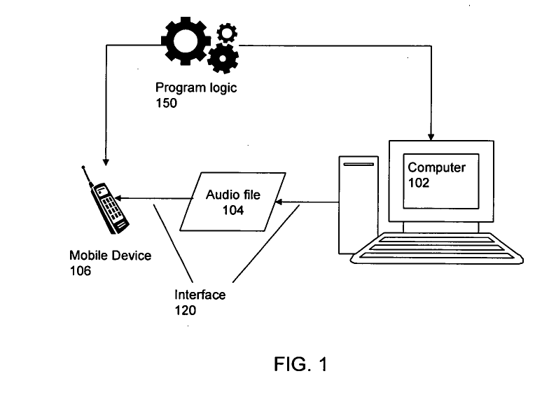

FIG. 1 is a block diagram illustrating a system for generating an audio file 104 describing data entries and transferring the audio file from a computer 102 to a mobile computing device 106, according to one embodiment of the present invention. FIG. 1 shows computer 102 which may be a desktop computer, a laptop computer, a PDA, a smart-phone, a game console, a media player or any computing mechanism that performs operations via a microprocessor, which is a programmable digital electronic component that incorporates the functions of a central processing unit (CPU) on a single semi-conducting integrated circuit (IC). One or more microprocessors typically serve as the CPU in a computer system, embedded system, or handheld device. FIG. 1 further shows a mobile device 106 which may be a PDA, a smart-phone, a media player or any mobile computing device that performs operations via a microprocessor.

FIG. 1 further shows that computer 102 is connected to the mobile computing device 106 via an interface 120. In one embodiment of the present invention, the interface 120 is a wired serial bus standard interface. Serial communications involve the process of sending data one bit at one time, sequentially, over a communications channel. For example, the interface 120 may be a USB serial data connection. USB is a serial bus standard to interface devices. USB allows peripherals to be connected using a single standardized interface socket, allowing devices to be connected and disconnected without rebooting the computer (hot swapping). USB also powers low-consumption devices without the need for an external power supply and allows some devices to be used without requiring individual device drivers to be installed. Another serial bus interface standard supported by the present invention includes IEEE 1394 (FireWire).

In another embodiment of the present invention, the interface 120 is a wireless data interface. For example, interface 120 may be a Bluetooth wireless data interface. Bluetooth is an industrial specification for wireless personal area networks. Bluetooth provides a way to connect and exchange information between devices such as mobile phones, laptops, personal computers, etc. over a secure, short-range radio frequency. Bluetooth is a standard and communications protocol primarily designed for low power consumption, with a short range. Interface 120 may also be an IEEE 802.11 data interface. IEEE 802.11 is a set of standards for wireless local area network computer communication in the multiple GHz public spectrum bands.

FIG. 1 shows that an audio file 104, generated using program logic 150, is transferred from computer 102 to mobile computing device 106 via interface 120. Program logic 150 may be present on computer 102, mobile computing device 106 or any combination of the two. The process by which program logic 150 generates audio file 104 is described in greater detail below. When the audio file 104 is transferred to mobile computing device 106, the audio file 104 may be stored on a non-volatile memory module on mobile computing device 106. A non-volatile computer memory, such as Flash memory, can be electrically erased and reprogrammed. Flash memory is a specific type of EEPROM that is erased and programmed in large blocks.

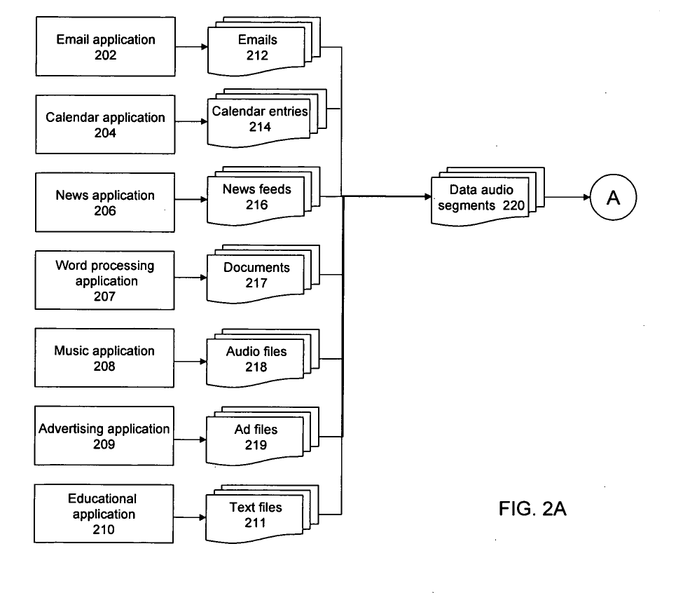

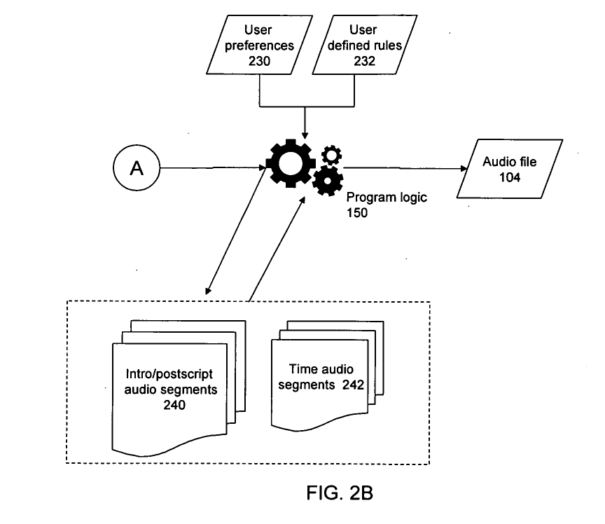

FIG. 2A is a block diagram illustrating a process for generating an audio file 104 describing data entries, wherein the audio file 104 includes continuity segments, according to one embodiment of the present invention. FIG. 2A shows that email application 202 has produced a plurality of emails 212, such as in .eml format, each of which may comprise a text portion. Calendar application 204 has produced a plurality of calendar entries 214, each of which may comprise a text portion. News application 206 has produced a plurality of news feeds or documents 216, such as in .txt. format, each of which may comprise a text portion. Word processing application 207 has produced a plurality of word processing documents 217, such as in .doc format, each of which may comprise a text portion. Music application 208 has produced a plurality of audio music files 218, such as in .wmv format. Advertising application 209 has produced a plurality of ad files 219, such as in .html format, each of which may comprise a text portion. An ad file 219 may includes an advertisement for a product. Educational application 210 has produced a plurality of educational documents 211, such as in .text format, each of which may comprise a text portion. An educational document 211 may include a tip on how to use a computing product or a general knowledge fact.

The following step may be executed by program logic 150. Next, the text portion of the each of the files 211, 212, 214, 216, 217 and 219 is converted to an audio segment using a text-to-speech program. All audio segments are grouped in a data audio segment group 220. Audio music files 219 are already in audio format and therefore are simply added to the data audio segment group 220. FIG. 2B is a continuation of the block diagram of FIG. 2A. FIG. 2B shows that data audio segment group 220 is read by program logic 150.

An introduction for a data audio segment refers to a spoken introduction of a data audio segment such as “We now have an email entitled White Paper from John Smith sent on Mar. 23, 2008” or “And now the jazz song River Blues by Alex Sambol.” An introduction for a data audio segment includes a brief spoken description of the data audio segment and is heard before the data audio segment is played. A postscript for a data audio segment refers to a brief spoken description of a data audio segment such as “And that was the classical music song Blue Danube by Tchaikovsky.” A postscript for a data audio segment is heard after the data audio segment. A time audio segment refers to a spoken indicator of how much time is left in the audio file 104, how much time has passed in the audio file 104, how many audio segments have been played and/or how many audio segments are remaining. Examples of time audio segments include “We are now 5 minutes through and we have 6 minutes remaining” and “We have 5 emails remaining.”

FIG. 2B further shows that user preferences 230 have been read by the program logic 150. User preferences 230 include preferences such as the voice used to voice the audio representing the text of each of the files 211, 212, 214, 216, 217 and 219 when they are converted to an audio segment using a text-to-speech program. User preferences 230 may also include preferences such as the text used for introductions of data audio segments, the text used for postscripts of data audio segments, the type and frequency of audio files 218 to use in the audio file 104, the type and frequency of news feeds 216 to use in the audio file 104, the type and frequency of ad files 219 to use in the audio file 104, the type and frequency of educational text files 211 to use in the audio file 104, the type and frequency of introduction or postscript audio segments to use in the audio file 104 and the type and frequency of time audio segments 242 to use in the audio file 104.

FIG. 2B further shows that user defined rules 232 have been read by the program logic 150. User defined rules 232 specify criteria that define the same preferences such as those described above for user preferences 230. The user defined rules 232 may define a rule such as “Insert an introduction audio segment before every data audio segment” or “Insert a time audio segment every 5 minutes.”

FIG. 2B further shows that program logic 150 produces introduction audio segments and postscript audio segments 240 according to the user preferences 230 and user defined rules 232 and further in light of the data audio segments 220. That is, once data audio segment group 220 is read, the program logic 150 reads and executes the user preferences 230 and user defined rules 232, thereby producing introduction audio segments and postscript audio segments 240. For example, if a user defined rule defines a rule such as “Insert an introduction audio segment before every data audio segment,” then the program logic produces an introduction audio segment for each data audio segment in data audio segment group 220. An introduction audio segment is meant for placement immediately before the data audio segment it introduces.

In one embodiment of the present invention, the user preferences 230 and user defined rules 232 may specify preferences for introduction audio segments and postscript audio segments 240 in a particular format including wildcards or placeholders. For example, a user defined rule may define a rule such as “Next we have a [insert genre of work] from [insert artist] entitled [insert title of work],” which could result in an actual introduction audio segment such as “Next we have a song from Jack Johnson entitled Orleans Landscape” or “Next we have an email from Bob Parr entitled Status Meeting Minutes.” Other examples of user preferences or user defined rules that specify preferences for introduction audio segments or postscript audio segments include: “And now [insert title of work], [insert genre of work] from [insert artist],” “Here is [insert artist] with [insert title of work],” and “That was [insert artist].”

Further, program logic 150 produces time audio segments 242 according to the user preferences 230 and user defined rules 232 in light of the data audio segments group 220. For example, if a user defined rule defines a rule such as “Insert a time audio segment every 5 minutes,” then the program logic produces a time audio segment for insertion into the audio file 104 after every 5 minutes of playback time.

Finally, program logic 150 produces the audio file 104 by combining the data audio segments group 220, the introduction audio segments and postscript audio segments 240 and the time audio segments 242. The audio file 104 is a single, continuous audio file that is generated by concatenating a specific combination of data audio segments group 220, the introduction audio segments and postscript audio segments 240 and the time audio segments 242. As explained above, the introduction audio segments are placed immediately before the data audio segment it describes, postscript audio segments are placed immediately after the data audio segment it describes and time audio segments are placed in the audio file 104 according the playback time specified in the user preferences 230 and user defined rules 232. Furthermore, data audio segments originating from news feeds 216, music audio files 218, ad files 219 and education text files 211 are placed in the audio file 104 specified in the user preferences 230 and user defined rules 232.

Embodiments of the invention can take the form of an entirely hardware embodiment or an embodiment containing both hardware and software elements. In a preferred embodiment, the invention is implemented in hardware. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for generating an audio file, comprising:
receiving a plurality of data entries, wherein each data entry comprises a text portion;
converting the text portion of each data entry into a data audio segment, thereby generating a plurality of data audio segments;
generating, for each data entry in a subset of the plurality of data entries, an introduction audio segment that describes a data entry, thereby producing a plurality of introduction audio segments; and
concatenating the plurality of data audio segments and the plurality of introduction audio segments into a single audio file, wherein each introduction audio segment is positioned in the audio file directly prior to a data audio segment corresponding to the data entry described by the introduction audio segment.

2. The method of claim 1, wherein the step of receiving further comprises:
receiving a plurality of data entries, wherein each data entry comprises a text portion wherein each data entry comprises any one of an email, a calendar entry and a document.

3. The method of claim 2, wherein the step of generating further comprises:
generating, for each data entry in the subset of the plurality of data entries, a postscript audio segment that describes a data entry, thereby producing a plurality of postscript audio segments.

4. The method of claim 3, wherein the step of concatenating further comprises:
concatenating the plurality of data audio segments, the plurality of introduction audio segments and the plurality of postscript audio segments into a single audio file, wherein each introduction audio segment is positioned in the audio file directly prior to a data audio segment corresponding to the data entry described by the introduction audio segment and wherein each postscript audio segment is positioned in the audio file directly after a data audio segment corresponding to the data entry described by the postscript audio segment.

5. The method of claim 2, wherein the step of generating further comprises:
generating a plurality of continuity audio segments, wherein each continuity audio segment comprises any one of a news report, an advertisement, and an educational segment.

6. The method of claim 5, wherein the step of concatenating further comprises:
concatenating the plurality of data audio segments, the plurality of introduction audio segments and the plurality of continuity audio segments into a single audio file, wherein each introduction audio segment is positioned in the audio file directly prior to a data audio segment corresponding to the data entry described by the introduction audio segment.

7. A computer program product comprising a computer usable medium embodying computer usable program code for generating an audio file, comprising:
computer usable program code for receiving a plurality of data entries, wherein each data entry comprises a text portion;
computer usable program code for converting the text portion of each data entry into a data audio segment, thereby generating a plurality of data audio segments;
computer usable program code for generating, for each data entry in a subset of the plurality of data entries, an introduction audio segment that describes a data entry, thereby producing a plurality of introduction audio segments; and
computer usable program code for concatenating the plurality of data audio segments and the plurality of introduction audio segments into a single audio file, wherein each introduction audio segment is positioned in the audio file directly prior to a data audio segment corresponding to the data entry described by the introduction audio segment.

8. The computer program product of claim 7, wherein the computer usable program code for receiving further comprises:
computer usable program code for receiving a plurality of data entries, wherein each data entry comprises a text portion wherein each data entry comprises any one of an email, a calendar entry and a document.

9. The computer program product of claim 8, wherein the computer usable program code for generating further comprises:
computer usable program code for generating, for each data entry in the subset of the plurality of data entries, a postscript audio segment that describes a data entry, thereby producing a plurality of postscript audio segments.

10. The computer program product of claim 9, wherein the computer usable program code for concatenating further comprises:
computer usable program code for concatenating the plurality of data audio segments, the plurality of introduction audio segments and the plurality of postscript audio segments into a single audio file, wherein each introduction audio segment is positioned in the audio file directly prior to a data audio segment corresponding to the data entry described by the introduction audio segment and wherein each postscript audio segment is positioned in the audio file directly after a data audio segment corresponding to the data entry described by the postscript audio segment.

11. The computer program product of claim 8, wherein the computer usable program code for generating further comprises:
computer usable program code for generating a plurality of continuity audio segments, wherein each continuity audio segment comprises any one of a news report, an advertisement, and an educational segment.

12. The computer program product of claim 11, wherein the computer usable program code for concatenating further comprises:
computer usable program code for concatenating the plurality of data audio segments, the plurality of introduction audio segments and the plurality of continuity audio segments into a single audio file, wherein each introduction audio segment is positioned in the audio file directly prior to a data audio segment corresponding to the data entry described by the introduction audio segment.

13. A computer system for generating an audio file, comprising:
a repository for storing a plurality of data entries, wherein each data entry comprises a text portion; and
a processor configured for:
converting the text portion of each data entry into a data audio segment, thereby generating a plurality of data audio segments;
generating, for each data entry in a subset of the plurality of data entries, an introduction audio segment that describes a data entry, thereby producing a plurality of introduction audio segments; and
concatenating the plurality of data audio segments and the plurality of introduction audio segments into a single audio file, wherein each introduction audio segment is positioned in the audio file directly prior to a data audio segment corresponding to the data entry described by the introduction audio segment.

14. The computer system of claim 13, wherein each data entry comprises any one of an email, a calendar entry and a document.

15. The computer system of claim 14, wherein the processor is further configured for:
generating, for each data entry in the subset of the plurality of data entries, a postscript audio segment that describes a data entry, thereby producing a plurality of postscript audio segments.

16. The computer system of claim 15, wherein the processor is further configured for:
concatenating the plurality of data audio segments, the plurality of introduction audio segments and the plurality of postscript audio segments into a single audio file, wherein each introduction audio segment is positioned in the audio file directly prior to a data audio segment corresponding to the data entry described by the introduction audio segment and wherein each postscript audio segment is positioned in the audio file directly after a data audio segment corresponding to the data entry described by the postscript audio segment.

17. The computer system of claim 14, wherein the processor is further configured for:
generating a plurality of continuity audio segments, wherein each continuity audio segment comprises any one of a news report, an advertisement, and an educational segment.

18. The computer system of claim 17, wherein the processor is further configured for:
concatenating the plurality of data audio segments, the plurality of introduction audio segments and the plurality of continuity audio segments into a single audio file, wherein each introduction audio segment is positioned in the audio file directly prior to a data audio segment corresponding to the data entry described by the introduction audio segment.

19. The computer system of claim 13, further comprising an interface for transmitting the audio file to a mobile computing device.
